(19) United States
(12) Patent Application Publication
(10) Pub. No.: US 2012/0026148 A1
(43) Pub. Date: Feb. 2, 2012

(54) ACTIVE MATRIX TYPE DISPLAY DEVICE AND ELECTRONIC DEVICE USING THE SAME

(75) Inventor: Kazuyuki Hashimoto, Miao-Li County (TW)

(73) Assignee: CHIMEI INNOLUX CORPORATION, Miao-Li County (TW)

(21) Appl. No.: 13/191,728

(22) Filed: Jul. 27, 2011

(30) Foreign Application Priority Data
Aug. 2, 2010 (JP) 2010-173327

(51) Int. Cl. G09G 5/00

(52) U.S. Cl. 345/211

(57) ABSTRACT

An active matrix display comprises pixels arranged in a matrix, signal lines, and scan lines orthogonal to the signal lines. Each pixel has a pixel electrode, a switch element connecting a corresponding signal line to the pixel electrode during a scan period, and a storage capacitor holding a signal voltage applied to the pixel electrode during the scan period. The storage capacitor connected between the pixel electrode and a capacity holding line corresponding to the pixel row. Every even number, above two, of the capacity storage lines are defined as a group. After all pixel rows corresponding to a group are scanned, the voltages of a half of the capacity storage lines in the group are switched from a first value to a second value, and the voltages of the other half of the capacity storage lines in the group are switched from the second value to the first value.

### CROSS REFERENCE TO RELATED APPLICATIONS

This Application claims priority of Japanese Patent Application No. 2010-173327, filed on Aug. 2, 2010, the entirety of which is incorporated by reference herein.

### BACKGROUND OF THE INVENTION

1. Field of the Invention

The present invention relates to an active matrix type display device and an electronic device using the same, comprising a plurality of pixels arranged in a matrix formed by rows and columns, a plurality of signal lines arranged corresponding to the columns, and a plurality of scan lines arranged corresponding to the rows to be orthogonal to the signal lines.

2. Description of the Related Art

In an active matrix display device having a plurality of pixels arranged in a matrix formed by rows and columns, each pixel comprises a switch element arranged at a intersection region of a signal line (also called a source line) and a scan line (also called a gate line). Each pixel further comprises a pixel electrode formed on a substrate together with the switch element, and a common electrode formed on an opposite substrate. A liquid crystal layer is situated between the two substrates. The common electrodes of all pixels are connected to a common and fixed voltage source. The switch element is conducted by responding to a scan signal transmitted by the scan line. A period of conduction of the switch element is usually called a scan period. In the scan period, the pixel electrode, via the switch element, is electrically connected to a source line, and a signal voltage is applied to the pixel electrode. The orientation of liquid crystal molecules in the liquid crystal layer is varied by the voltage difference produced between the pixel electrode and the common electrode.

Each pixel further comprises a storage capacitor holding a signal voltage in the form of electrical charges during the period from the end of a scan period through the beginning of the next scan period. The period means a period in which pixel data is being rewritten (also called a frame). The storage capacitor has a first terminal connected to the pixel electrode and a second terminal connected to a capacity storage line (also called a CS line). A capacity storage line is arranged on each row and parallel with the gate line.

In the past, a capacitive coupled driving scheme has been used for reducing the power consumption of the active matrix type liquid crystal display device. The method synchronizes a gate driver which drives gate lines and a capacity storage driver which drives capacity storage lines, to inversely drive each capacity storage line arranged corresponding to each pixel row after the end of the scan period. Because of the driving of the capacity storage line, the pixel electrode is applied a predetermined bias voltage via the storage capacitor (for example, Japanese published patent, No. 3402277). Therefore, in comparison with not having capacitive coupled driving scheme, the capacitive coupled driving scheme can reduce the amplitude of signal voltages so as to reduce power consumption.

However, because of the effect of capacitive coupling, the conventional capacitive coupled driving scheme has a problem that when the capacity storage line is being inversely driven charge injection noise appears on the common electrode; especially, for a display device comprising a static capacity type touch panel, wherein such noise causes a problem where touch sensing cannot be accurately performed. In order to restrain the noise, there are strategies such as increasing the predetermined voltage source connected to the common electrode and widening of wires, but these strategies bring new problems such as high power consumption and large-sized devices.

In order to deal with the above situation, the purpose of the invention is to provide an active matrix type display device and an electronic device using the same which use a capacitive coupled driving scheme with low power consumption and low noise.

### BRIEF SUMMARY OF THE INVENTION

A detailed description is given in the following embodiments with reference to the accompanying drawings.

An active matrix type display device in accordance with an embodiment of the invention includes a plurality of pixels arranged in a matrix formed by rows and columns, a plurality of signal lines arranged corresponding to the columns, and a plurality of scan lines arranged corresponding to the rows and orthogonal to the signal lines. The active matrix type display device further includes: a pixel electrode arranged at each of the plurality of pixels; a switch element arranged at each of the plurality of pixels, wherein in a pixel, during a period in which one of the plurality of scan lines arranged corresponding to a row which the pixel electrode belongs to is providing a scan signal to the pixel, the switch element electrically connects one of the plurality of signal lines arranged corresponding to a column which the pixel electrode belongs to, to the pixel electrode to apply a signal voltage to the pixel electrode; a storage capacitor arranged at each of the plurality of pixels, wherein the storage capacitor comprises a first terminal and a second terminal, wherein the first terminal is connected to the pixel electrode for holding the signal voltage applied to the pixel electrode; a plurality of capacity storage lines arranged corresponding to the rows, wherein one of the plurality of capacity storage lines corresponding to the row which the pixel electrode belongs to is connected to the second terminal of the storage capacitor; and a voltage switch device, wherein for a group defined by two or every other even number above two of the capacity storage lines, the voltage switch device responds to the end of the scan period of all pixels belonging to the group and switches the voltages of a half of the capacity holding lines in the group from a first value to a second value while switching the voltages of the other half of the capacity storage lines in the group from the second value to the first value.

In an embodiment, the active matrix type display device of the invention can be applied to electronic devices with display panels for providing users with images, such as a television, a cell phone, a watch, a PDA, a laptop or desktop computer, a car navigation device, a portable game device, an AURORA VISION, or etc.

According to the embodiment of the invention, an active matrix type display device and an electronic device using the same which uses a capacitive coupling driving method with low power consumption and low noise are provide.

### BRIEF DESCRIPTION OF THE DRAWINGS

The present invention can be more fully understood by reading the subsequent detailed description and examples with references made to the accompanying drawings, wherein:

FIG. 1 is a block diagram of an active matrix type display device in accordance with an embodiment of the invention.

FIG. 2 is a circuitry diagram of pixels in the active matrix type display device in accordance with an embodiment of the invention.

FIG. 3 shows voltage waveforms of each part of the pixel circuit in FIG. 2, wherein the capacity storage lines are driven by the conventional capacitive coupled driving scheme.

FIG. 4 shows voltage waveforms of each part of the pixel circuit in FIG. 2, wherein the capacity storage lines 18-1˜18-n are driven by the capacitive coupled driving scheme in accordance with an embodiment of the invention.

FIG. 5 is a block diagram of the capacity storage driver of the active matrix type display device in accordance with an embodiment of the invention.

FIG. 6 is an example showing an electronic device provided with the active matrix type display device in accordance with an embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

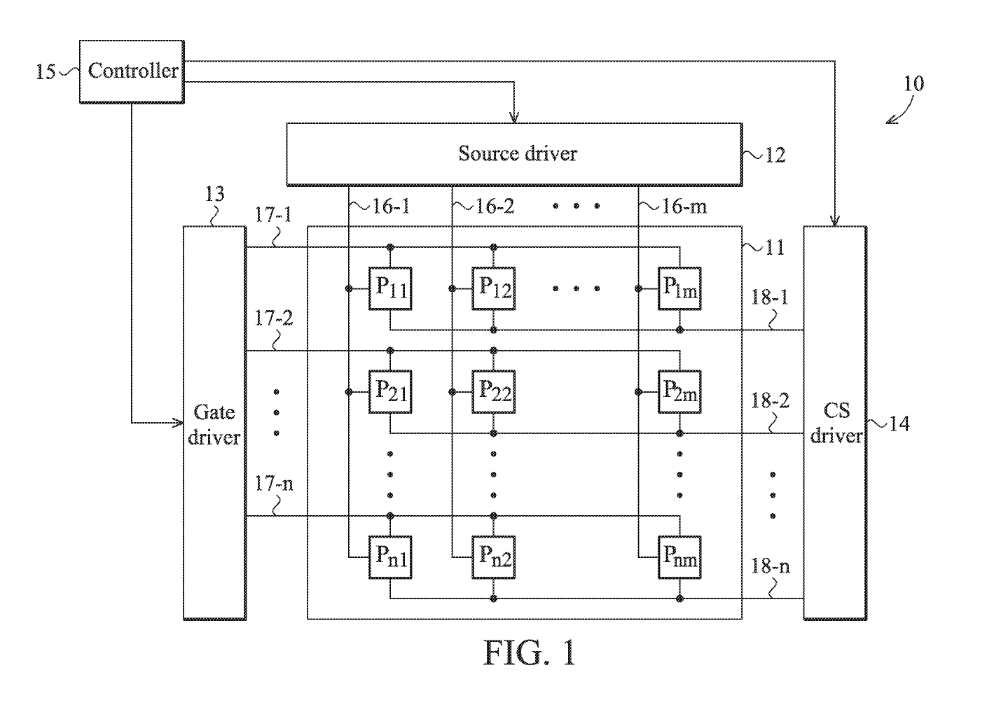

FIG. 1 is a block diagram of an active matrix type display device in accordance with an embodiment of the invention. In FIG. 1, a display device 10 comprises a display panel 11, a source driver 12, a gate driver 13, a capacity storage driver 14 (also called a CS driver), and a controller 15. The display panel 11 comprises a plurality of pixels P₁₁˜Pₙₘ (m and n are integers) arranged in a matrix formed by rows and columns. The display panel 11 further comprises a plurality of source lines 16-1˜16-m arranged corresponding to the columns, a plurality of gate lines 17-1˜17-n arranged corresponding to the rows and orthogonal to the source lines 16-1˜16-m, and a plurality of capacity storage lines 18-1˜18-n arranged corresponding to the rows and parallel with the gate lines 17-1˜17-n.

The source driver 12 applies signal voltages to the pixels P₁₁˜Pₙₘ via the source lines 16-1˜16-m. The gate driver 13 controls signal voltage applying timings of the pixels P₁₁˜Pₙₘ via the gate lines 17-1˜17-n. Specifically, the gate driver 13 drives pixels on a row with an interlaced scan or progressive scan procedure so that the pixels on that row are applied with signal voltages through the source lines. For example, in the liquid crystal display device, by applying of the signal voltages, the orientation of the liquid crystal molecules is varied so as to polarize back light or external light (reflected light) to display images.

The capacity storage driver 14 provides a reference voltage to a storage capacitor arranged in each pixel via one of the capacity storage lines 18-1˜18-n in order to hold the signal voltage applied on the pixel till the next driving of the pixel.

The controller 15 synchronizes the source driver 12, the gate driver 13, and the capacity storage driver 14, and controls the above devices.

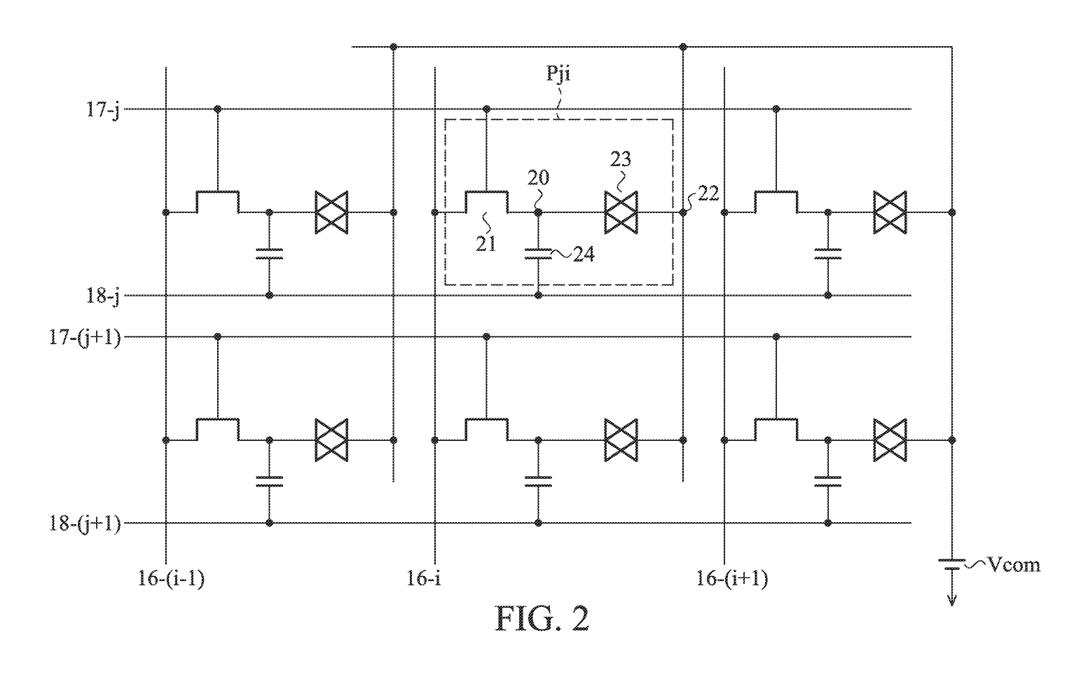

FIG. 2 is a circuitry diagram of pixels in the active matrix type display device in accordance with an embodiment of the invention. The pixel Pⱼᵢ (i and j are integers, wherein 1≦i≦m and 1≦j≦n) are arranged at the cross region of the i-th source line 16-i and the j-th gate line 17-j.

The pixel Pⱼᵢ comprises a pixel electrode 20, a switch element 21 formed on a substrate together with the pixel electrode 20, and a common electrode 22 formed on an opposite substrate which faces the pixel electrode 20 across a liquid crystal layer. Briefly, the element between the pixel electrode 20 and the common electrode 22 in FIG. 2 is represented by a liquid crystal display element 23.

The common electrode 22 connects all pixels P₁₁˜Pₙₘ to a common and fixed voltage source V_{COM}.

The control terminal of the switch element 21 is connected to the gate line 17-j. The switch element 21 responds to a scan signal transmitted by the gate line 17-j and then is conducted. During the scan period in which the switch element 21 is conducted, the pixel electrode 20 is electrically connected to the source line 16-i via the switch element 21. Therefore, the signal voltage is applied to the pixel electrode 20 and the liquid crystal display element 23 is driven by the voltage difference produced between the pixel electrode 20 and the common electrode 22.

The pixel Pⱼᵢ further comprises a storage capacitor 24 holding a signal voltage in the form of electrical charges during the period from the end of a scan period through the beginning of the next scan period. The period means a period in which pixel data is being rewritten (also called a frame). One terminal of the storage capacitor 24 is connected to the pixel electrode 20 and the other terminal is connected to a capacity storage line 18-j.

Via the capacity storage driver 14, the capacity storage lines 18-1˜18-n are synchronized with the gate lines 17-1˜17-n and inversely drive the pixels P₁₁˜Pₙₘ. Because of the driving of the capacity storage line 18-j, the pixel electrode 20 is applied with a predetermined bias voltage via the storage capacitor 20. The method which shifts the potential of the pixel electrode by driving of the capacity storage line is usually called a capacitive coupling driving method. In comparison with no capacitive coupling driving method, the capacitive coupling driving method can reduce the amplitude of signal voltages so as to reduce power consumption.

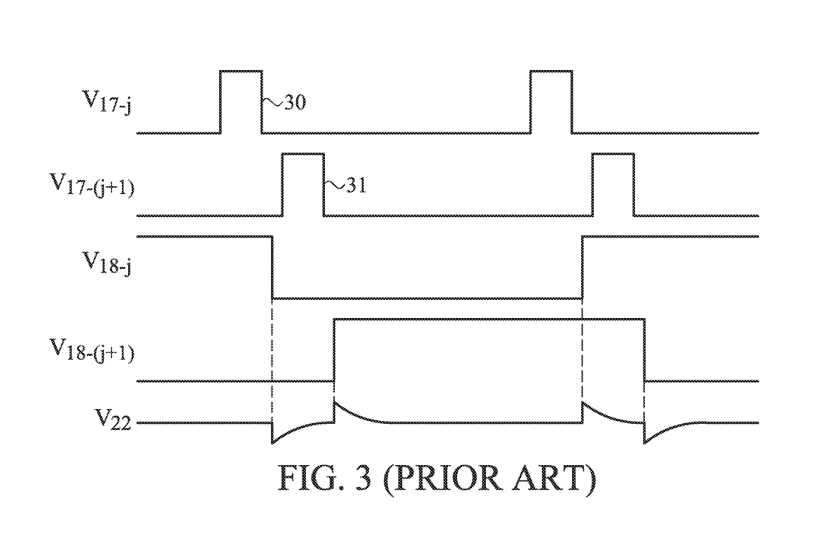

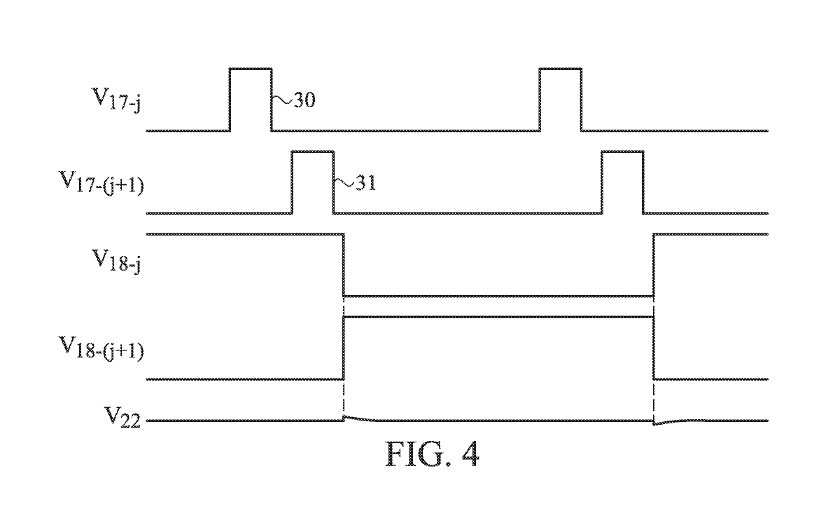

Now refer to FIGS. 3 and 4, wherein details about the driving of the capacity storage line are described below.

FIG. 3 shows voltage waveforms of each part of the pixel circuit in FIG. 2, wherein the capacity storage lines 18-1˜18-n are driven by the conventional capacitive coupled driving scheme.

In the example shown in FIG. 3, the gate driver 13 applies a scan signal 30 to the gate line 17-j to drive the pixels Pⱼ₁˜Pⱼₘ on the j-th row. During the scan period in which the scan signal 30 is applied, the source driver 12 applies a data signal to the pixels Pⱼ₁˜Pⱼₘ on the j-th row via the source lines 16-1˜16-m. The capacity storage driver 14 responds to the end of the scan period of the pixels Pⱼ₁˜Pⱼₘ on the j-th row and switches the voltage level on the capacity storage line 18-j from a first value to a second value. In this example, the voltage level on the capacity storage line 18-j is switched from High to Low.

Next, the gate driver 13 applies a scan signal 31 to the gate line 17-(j+1) to drive the pixels P₍ⱼ₊₁₎₁˜P₍ⱼ₊₁₎ₘ on the (j+1)-th row. During the scan period in which the scan signal 31 is applied, the source driver 12 applies a data signal to the pixels P₍ⱼ₊₁₎₁˜P₍ⱼ₊₁₎ₘ on the (j+1)-th row via the source lines 16-1˜16-m. The capacity storage driver 14 responds to the end of the scan period of the pixels P₍ⱼ₊₁₎₁˜P₍ⱼ₊₁₎ₘ on the (j+1)-th row and switches the voltage level on the capacity storage line 18-(j+1) from a second value to a first value.

In the conventional capacitive coupling driving method, it can be understood from FIG. 3 that noise appears on the common electrode 22 when the capacity storage lines 18-j and 18-(j+1) switch voltage levels. The phenomenon is caused because an electric charge injection due to capacitive coupling of the storage capacitor 24 and the liquid crystal display element 23 happens between the capacity storage line and the common electrode 22.

FIG. 4 shows voltage waveforms of each part of the pixel circuit in FIG. 2, wherein the capacity storage lines 18-1˜18-n are driven by the capacitive coupled driving scheme in accordance with an embodiment of the invention.

Similar to the example of FIG. 3, the gate driver 13 applies a scan signal 30 to the gate line 17-j to drive the pixels Pⱼ₁˜Pⱼₘ on the j-th row. During the scan period in which the scan signal 30 is applied, the source driver 12 applies a data signal to the pixels Pⱼ₁˜Pⱼₘ on the j-th row via the source lines 16-1˜16-m. The difference from the example of FIG. 3 is that the capacity storage driver 14 does not respond to the end of the scan period of the pixels Pⱼ₁˜Pⱼₘ on the j-th row to switch the voltage level on the capacity storage line 18-j between two values.

Next, the gate driver 13 applies a scan signal 31 to the gate line 17-(j+1) to drive the pixels P₍ⱼ₊₁₎₁˜P₍ⱼ₊₁₎ₘ on the (j+1)-th row. During the scan period in which the scan signal 31 is applied, the source driver 12 applies a data signal to the pixels P₍ⱼ₊₁₎₁˜P₍ⱼ₊₁₎ₘ on the (j+1)-th row via the source lines 16-1˜16-m. The capacity storage driver 14 responds to the end of the scan period of the pixels P₍ⱼ₊₁₎₁˜P₍ⱼ₊₁₎ₘ on the (j+1)-th row and switches the voltage level on the capacity storage line 18-j from a first value to a second value while switching the voltage level on the capacity storage line 18-(j+1) from the second value to the first value. In this example, the voltage level on the capacity storage line 18-j is switched from High to Low, and the voltage level on the capacity storage line 18-(j+1) is switched from Low to High.

In this way, two adjacent capacity storage lines are defined as a group and the capacity storage driver responds to the end of the scan period of all corresponding pixel rows to inversely drive the two adjacent capacity storage lines symmetrically (for example, with opposite polarities each other). As shown in FIG. 4, the charge injection noise appearing on the common electrode 22 is almost offset.

In the example shown in FIG. 4, briefly, with regard to a group consisting of two adjacent capacity storage lines, the capacity storage driver 14 inversely drives the two capacity storage lines simultaneously and symmetrically (for example, with opposite polarities each other). However, the capacitive coupling driving method in accordance with the invention can be applied to drive the capacity storage lines 18-1˜18-n even in the case where even numbers above four of the capacity storage lines are defined as a group. In this case, for each group of capacity storage lines, the capacity storage driver 14 responds to the end of the scan period of all pixel rows corresponding to the capacity storage lines included in the group and switches the voltage level of a half of the capacity storage lines from the first value to the second value (or from the second value to the first value) and switches the voltage level of the other half of the capacity storage lines from the second value to the first value (or from the first value to the second value).

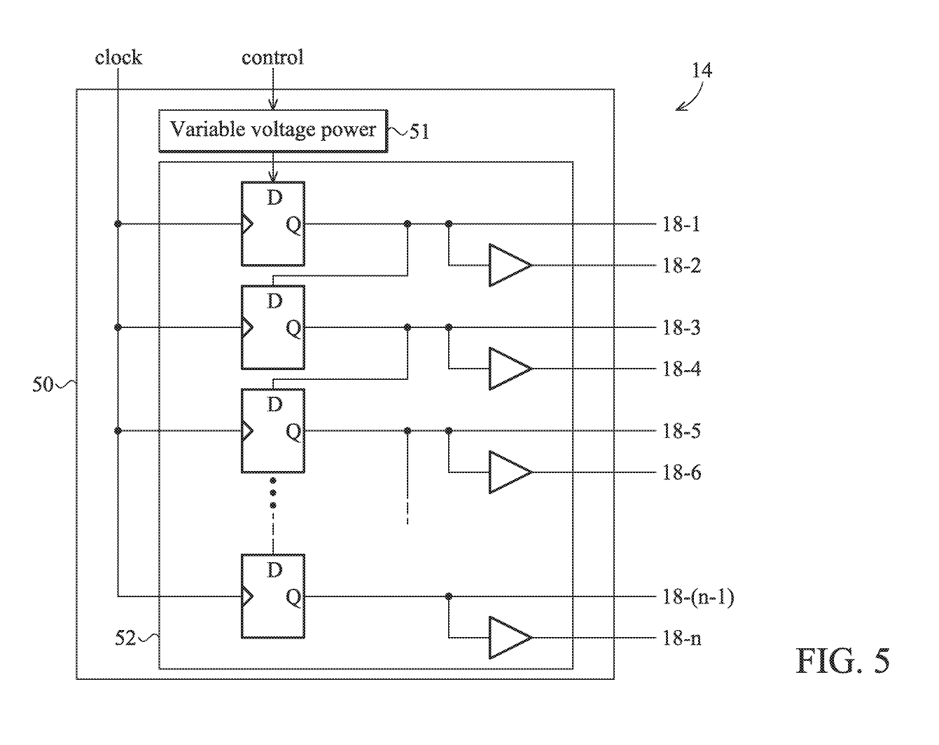

FIG. 5 is a block diagram of the capacity storage driver of the active matrix type display device in accordance with an embodiment of the invention.

The capacity storage driver 14 comprises a voltage switch part 50 switching the voltage provided to the capacity storage lines 18-1˜18-n. The voltage switch part 50 is provided with a variable voltage power 51 and a voltage distribution part 52. The variable voltage power 51 responds to a control signal provided from the controller 15 and switches output voltages between two values. The voltage distribution part 52 responds to a clock signal provided from the controller 15 to distribute voltages provided from the variable voltage power 51 to every capacity storage line. The clock signal can be used to control the provision of the scan signals from the plurality of scan lines in display panel 11.

For example, as shown in FIG. 5, the voltage distribution part 52 can comprise level shifters using delay flip-flops (D-FF). It can be understood from FIG. 5 that in comparison with the prior art the number of the D-FF is reduced by half because even numbers above two of the capacity storage lines are defined as a group. Therefore, the circuit scale of the capacity storage driver can be reduced. In this case, the circuit of the capacity storage driver can be formed on the substrate where the pixel electrode, the switch element, the storage capacitor, the source line, the gate line, and the capacity storage line are formed. In an alternative embodiment, the capacity storage driver can be fabricated together with the source driver and the gate driver to a driver integrated circuit which is disposed apart from the display panel.

From the above description, it is understood that the active matrix type display device in accordance with an embodiment can solve the problem of charge injection noise accompanied with the capacitive coupling driving method without adopting the strategies such as increasing the predetermined voltage source connected to the common electrode and widening of wires. Therefore, problems such as high power consumption and large-sized devices are eliminated in the present invention. Furthermore, as the description of FIG. 5 shows, the active matrix type display device in accordance with an embodiment can reduce power consumption and device scale because the circuit scale of the capacity storage driver is reduced.

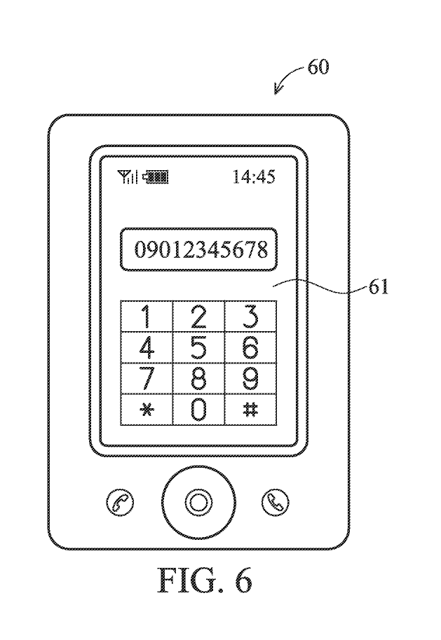

FIG. 6 is an example showing an electronic device provided with the active matrix type display device in accordance with an embodiment of the invention. The electronic device 60 in FIG. 6 is represented by a cell phone, but other electronic devices such as a television, a watch, a PDA, a laptop or desktop computer, a car navigation device, a portable game device, an AURORA VISION, or etc. is also suitable for the invention.

The cell phone 60 is provided with a display device 61, and the display device 61 has a display panel to show information in the form of images. The display device 61 can also have a touch panel function. In addition to showing time or the state information of the cell phone such as signal intensity and the amount of battery power remaining, the display device 61 allows users to touch the surface of the display panel to operate the number key. For example, the display device 61 is provided with a static capacitive type touch panel to realize related functions of a touch panel.

The touch panel is usually disposed in the substrate where the common electrode is formed (in some situations, a polarizer is sandwiched between the touch panel and the substrate). According to the conventional capacity storage line driving method shown in FIG. 3, charge injection noise appearing on a common electrode may negatively effect touch sensing. However, according to the capacity storage line driving method of the present invention shown in FIG. 4, charge injection noise appearing on the common electrode is offset, therefore touch sensing does not suffer from negative effects of charge injection noise. In addition to low power consumption, a small circuit scale of a common electrode and capacity storage driver can be achieved.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An active matrix type display device, comprising a plurality of pixels arranged in a matrix formed by rows and columns, a plurality of signal lines arranged corresponding to the columns, and a plurality of scan lines arranged corresponding to the rows and orthogonal to the signal lines, wherein the active matrix type display device further comprises:
a pixel electrode arranged at each of the plurality of pixels;
a switch element arranged at each of the plurality of pixels, wherein in a pixel, during a period in which one of the plurality of scan lines arranged corresponding to a row which the pixel electrode belongs to is providing a scan signal to the pixel, the switch element electrically connects one of the plurality of signal lines arranged corresponding to a column which the pixel electrode belongs to, to the pixel electrode to apply a signal voltage to the pixel electrode;
a storage capacitor arranged at each of the plurality of pixels, wherein the storage capacitor comprises a first terminal and a second terminal and the first terminal is connected to the pixel electrode for holding the signal voltage applied to the pixel electrode;
a plurality of capacity storage lines arranged corresponding to the rows, wherein one of the plurality of capacity storage lines corresponding to the row which the pixel electrode belongs to is connected to the second terminal of the storage capacitor; and
a voltage switch device, wherein for a group defined by two or every other even number above two of the capacity storage lines, the voltage switch device responds to the end of the scan period of all pixels belonging to the group and switches the voltages of a half of the capacity storage lines in the group from a first value to a second value while switching the voltages of the other half of the capacity storage lines in the group from the second value to the first value.

2. The active matrix type display device as claimed in claim 1, wherein the voltage switch device comprises:
a variable voltage source capable of switching an output voltage between two values; and
a voltage distribution device responding to the provision of the scan signals from the plurality of scan lines to the plurality of rows and distributing the output voltage of the variable voltage source to each of the plurality of capacity storage lines.

3. The active matrix type display device as claimed in claim 1, wherein the active matrix type display device is a liquid crystal display device, and the active matrix type display device further comprises:
a first substrate comprising circuits formed by the plurality of signal lines, the plurality of scan lines, the pixel electrode, the switch element, the storage capacitor, and the plurality of capacity storage lines; and
a second substrate comprising a common electrode facing the circuits across a liquid crystal layer,
wherein the voltage switch device is formed on the first substrate together with the circuits.

4. The active matrix type display device as claimed in claim 1, wherein the active matrix type display device is a liquid crystal display device, and the active matrix type display device further comprises:
a first substrate comprising circuits formed by the plurality of signal lines, the plurality of scan lines, the pixel electrode, the switch element, the storage capacitor, and the plurality of capacity storage lines;
a second substrate comprising a common electrode facing the circuits across a liquid crystal layer; and
a driver integrated circuit comprising the voltage switch device.

5. An electronic device comprising the active matrix type display device as claimed in claim 1.
